(19) United States
(12) Patent Application Publication
(10) Pub. No.: US 2007/0180451 A1
(43) Pub. Date: Aug. 2, 2007

(54) System and method for meta-scheduling

(76) Inventors: Michael J. Ryan, Poughkeepsie, NY (US); Ty Panagoplos, New York, NY (US); Peter J. Krey JR., Mamaroneck, NY (US); Adrian E. Kunzle, New York, NY (US)

Correspondence Address: MILBANK, TWEED, HADLEY & MCCLOY, 1 CHASE MANHATTAN PLAZA, NEW YORK, NY, 10005-1413, US

(21) Appl. No.: 11/642,370

(22) Filed: Dec. 19, 2006

Related U.S. Application Data
(60) Provisional application No. 60/755,500, filed on Dec. 30, 2005.

(51) Int. Cl. G06F 9/46

(52) U.S. Cl. 718/104

(57) ABSTRACT

In certain aspects, the invention features a system that includes a number of grid-cluster schedulers, wherein each grid-cluster scheduler has software in communication with a number of computing resources, wherein each of the computing resources has an availability, and wherein the grid-cluster scheduler is configured to obtain a quantity of said computing resources as well as the availability and to allocate work for a client application to one or more of the computing resources based on the quantity and availability of the computing resources. In such aspects, the system further includes a meta-scheduler in communication with the grid-cluster schedulers, wherein the meta-scheduler is configured to direct work dynamically for one or more client applications to at least one of the grid-cluster schedulers based at least in part on data from each of the grid-cluster schedulers. Further aspects concern systems and methods that include: receiving, for computation by one or more clusters of a distributed computing system, work of a client application; sending a job to each cluster and gathering telemetry data based on a response from each cluster to the job; normalizing the telemetry data from each cluster; determining which of the clusters are able to accept the client application's work; and determining which of the clusters will receive a portion of the work.

### CROSS-REFERENCE TO RELATED APPLICATIONS

This application claims the benefit of U.S. Provisional Application No. 60/755,500, filed Dec. 30, 2005.

### BACKGROUND

I. Field of the Invention

The present invention relates to the structure and operation of distributed computing systems, and more particularly, to systems and methods for scheduling computing operations on multiple distributed computing systems or portions thereof.

II. Description of Related Art

Certain organizations have a need for high performance computing resources. For example, a financial institution may use such resources to perform risk-management modeling of valuations for particular instruments and portfolios at specified points in time. As another example, a pharmaceutical manufacturer may use high-performance computing resources to model the effects, efficacy, and/or interactions of new drugs it is developing. As a further example, an oil exploration company may evaluate seismic information using high-performance computing resources.

Upon request, a scheduler of a high performance computer system may route a specific piece of work to a given computer or group of interconnected, networked, and/or physically co-located computers known as a “cluster.” But at least some conventional schedulers continue to accept work even if all computing resources in the cluster are unavailable or busy. Work that cannot be allocated for computation may remain in the scheduler's queue for an unacceptable amount of time. Also, some conventional schedulers only control clusters of a known and fixed number of computing resources. Such conventional schedulers may have no notion of distributed computing systems (“grids”) or portions thereof beyond the scope of a single cluster. Therefore, the concepts of peer clusters, hierarchy of clusters, and relationships between clusters required for a truly global grid may not be realized by such schedulers.

For example, certain schedulers are told a priori “these are the 100 computers in your cluster.” Such schedulers then contact each one and determine how many central processing units (CPUs) and other schedulable resources each one has, and then sets up communication with them. Thus, for some conventional schedulers, the cluster is the widest scope of resources known to the software when it comes to distributing work, sharing resources, and anything else related to getting work done on a grid. In other conventional schedulers, the scheduling software may not know which particular machines will be available at any given point in time. Both the a priori and dynamic-resource models can be found in open-source and proprietary-vendor offerings.

Aspects of the present invention may help address shortcomings in the current state of the art in grid middleware software and may provide the ability to schedule work across multiple heterogeneous portions of distributed computing systems.

### SUMMARY OF THE INVENTION

In one aspect, the invention concerns a system that includes a number of grid-cluster schedulers, wherein each grid-cluster scheduler has software in communication with a number of computing resources, wherein each of the computing resources has an availability, and wherein the grid-cluster scheduler is configured to obtain a quantity of said computing resources as well as said availability and to allocate work for a client application to one or more of the computing resources based on the quantity and availability of the computing resources. In such an aspect, the system further includes a meta-scheduler in communication with the grid-cluster schedulers, wherein the meta-scheduler is configured to direct work dynamically for one or more client applications to at least one of the grid-cluster schedulers based at least in part on data from each of the grid-cluster schedulers.

In another aspect, the invention concerns a middleware software program functionally upstream of and in communication with one or more cluster schedulers of one or more distributed computing systems, wherein the middleware software program dynamically controls where and how work from a client application is allocated to the cluster schedulers.

In a further aspect, the invention concerns a method that includes: receiving, for computation by one or more clusters of a distributed computing system, work of a client application; sending a job to each cluster and gathering telemetry data based on a response from each cluster to the job; normalizing the telemetry data from each cluster; determining which of the clusters are able to accept the client application's work; and determining which of the clusters will receive a portion of the work.

In yet another aspect, the invention concerns a system that includes: means for receiving, for computation by one or more clusters of a distributed computing system, work of a client application; means for sending a job to each cluster and gathering telemetry data based on a response from each cluster to the job; means for normalizing the telemetry data from each cluster; means for determining which of the clusters are able to accept the client application's work; and means for determining which of the clusters will receive a portion of the work.

### BRIEF DESCRIPTION OF THE DRAWINGS

Features and other aspects of the invention are explained in the following description taken in conjunction with the accompanying drawings, wherein:

FIG. 1 illustrates a system with a distributed computing system 300 that has a meta-scheduler 10 in communication with other aspects of the distributed computing system 300, according to one embodiment of the present invention;

FIG. 2 illustrates components of the meta-scheduler 10 shown in FIG. 1;

FIG. 3 illustrates a system with a distributed computing system 300-1 that has a plurality of meta-schedulers 10-1, 10-2, etc. in communication with each other and other aspects of a distributed computing system 300, according to another embodiment of the present invention;

FIG. 4 illustrates components of a meta-scheduler 10-1 shown in FIG. 3;

FIG. 5 illustrates components of a scheduler 30 according to an embodiment of the present invention;

FIG. 6 illustrates an embodiment of a method of allocating work using a meta-scheduler 10;

FIG. 7 illustrates an embodiment of a method of allocating work between two types of clusters using a meta-scheduler 10; and

FIG. 8 illustrates, according to an embodiment of the present invention, an interaction between a meta-scheduler 10 and an instance of one type of distributed resource manager (“DRM” or “scheduler” 30; e.g., a Condor DRM), including its job-allocation module or “negotiator.”

The drawings are exemplary, not limiting. Additional disclosure and drawings are contained in U.S. Provisional Application No. 60/755,500, all of which is incorporated by reference herein. U.S. Pat. No. 6,895,472 is also incorporated by reference herein.

### DETAILED DESCRIPTION OF PREFERRED EMBODIMENTS

Various embodiments of the present invention will now be described in greater detail with reference to the drawings.

### I. System Embodiments of the Invention

A. Scheduler 30

A scheduler 30 of a distributed computing system 300 may switch or route incoming work to appropriate computing resources within a corresponding cluster 700. For example, based on an algorithm computed by the scheduler 30, a particular “job” (e.g., a related set of calculations that collectively work toward providing related results) of an application 20 may be sent to a particular set of CPU's within a cluster 700 that is available for processing.

In one embodiment, the scheduler 30 may use policy and priority rules to allocate, for a particular client 1, the resources of multiple CPUs in a particular cluster 700. Upon request, this scheduler 30 also may route a specific piece of work to a given computer or group of computers within the cluster 700. At any present particular time, a scheduler 30 (whether it uses a static allocation technique or a discovery technique) knows how many machines are available to it, how many are busy, and how many are idle. The scheduler 30 may provide this information (or a summary thereof) to the meta-scheduler 10.

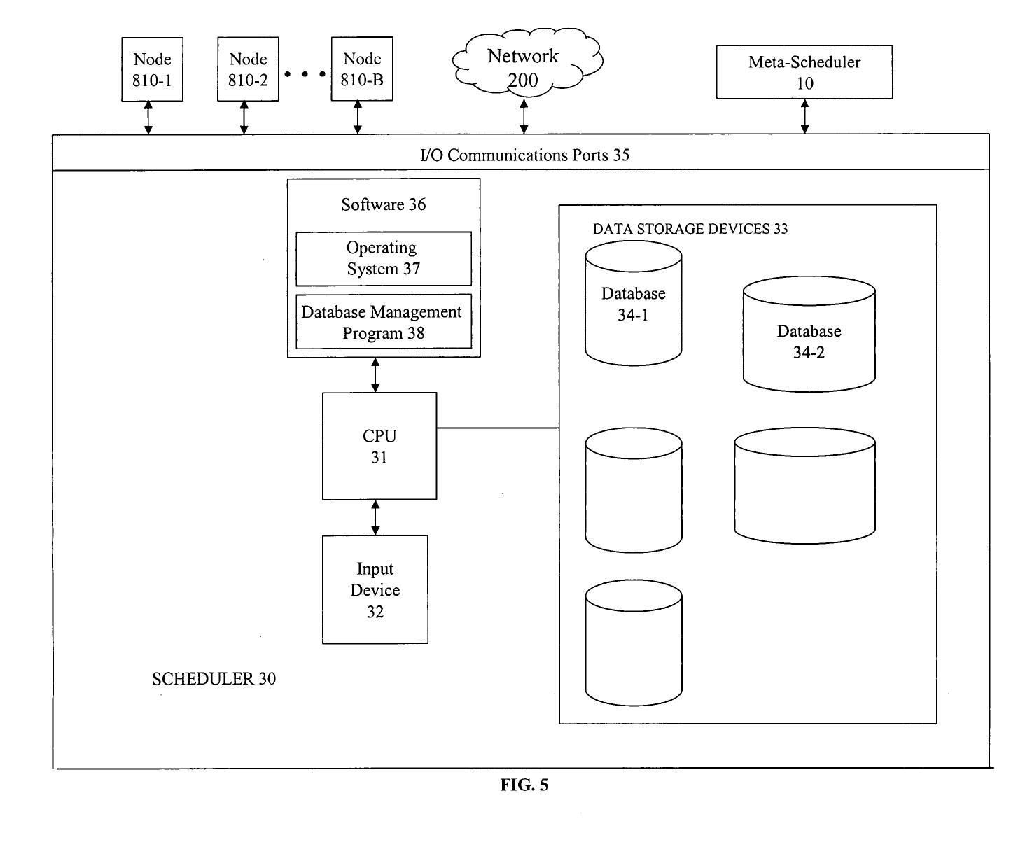

As shown in FIG. 5, the scheduler 30 of one embodiment may be a server having a CPU 31 that is in communication with a number of components by a shared data bus or by dedicated connections. Such components may include one or more input devices 32 (e.g., CD-ROM drive and/or tape drive) that may enable instructions and information to be input for storage in the scheduler 30, one or more data storage devices 33 (having one or more databases 34 defined therein), input/output (I/O) communications ports 35, and software 36. Each I/O communications port 35 may have multiple communication channels for simultaneous connections. The software 36 may include an operating system 37 and data management programs 38 configured to store information and perform the operations or transactions described herein. The scheduler 30 of one embodiment may access data storage devices 33 which may contain a number of databases 34-1, 34-2, etc. The scheduler 30 may, for example, include a single server or a plurality of servers. The computers or nodes 810-1, 810-2, etc. known to the scheduler 30 may include, for example, servers and/or personal computers.

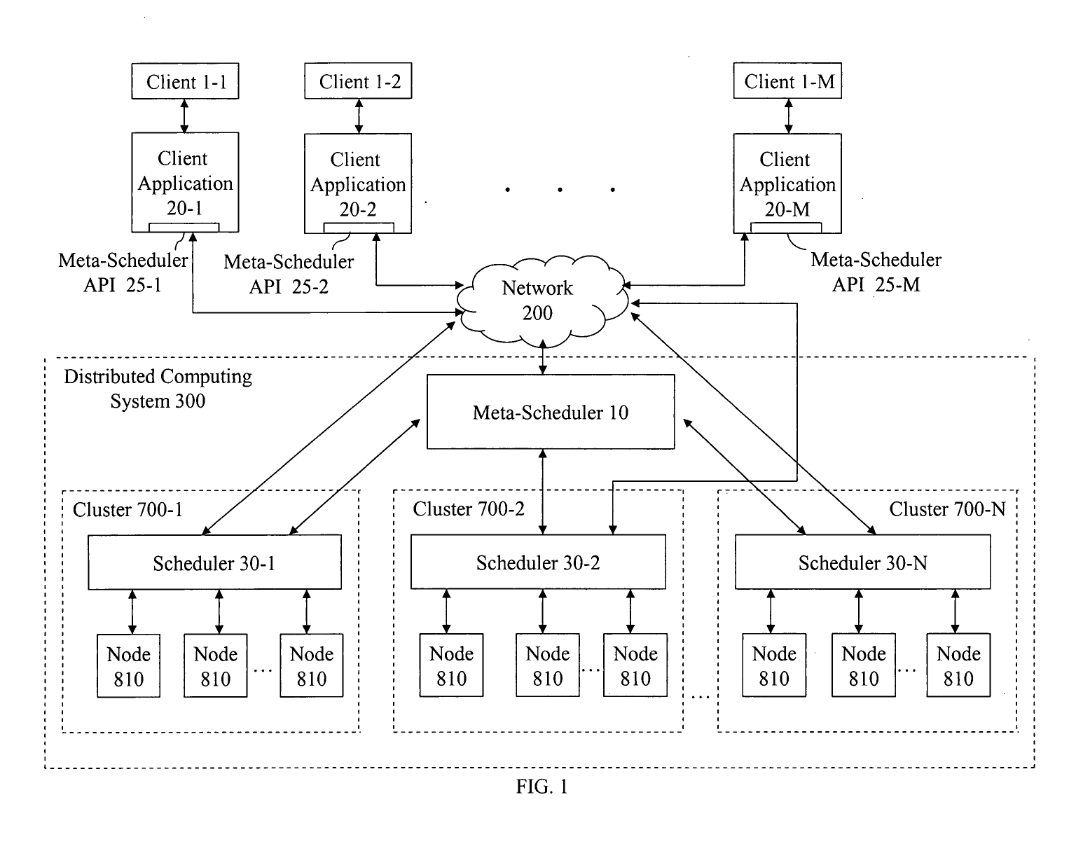

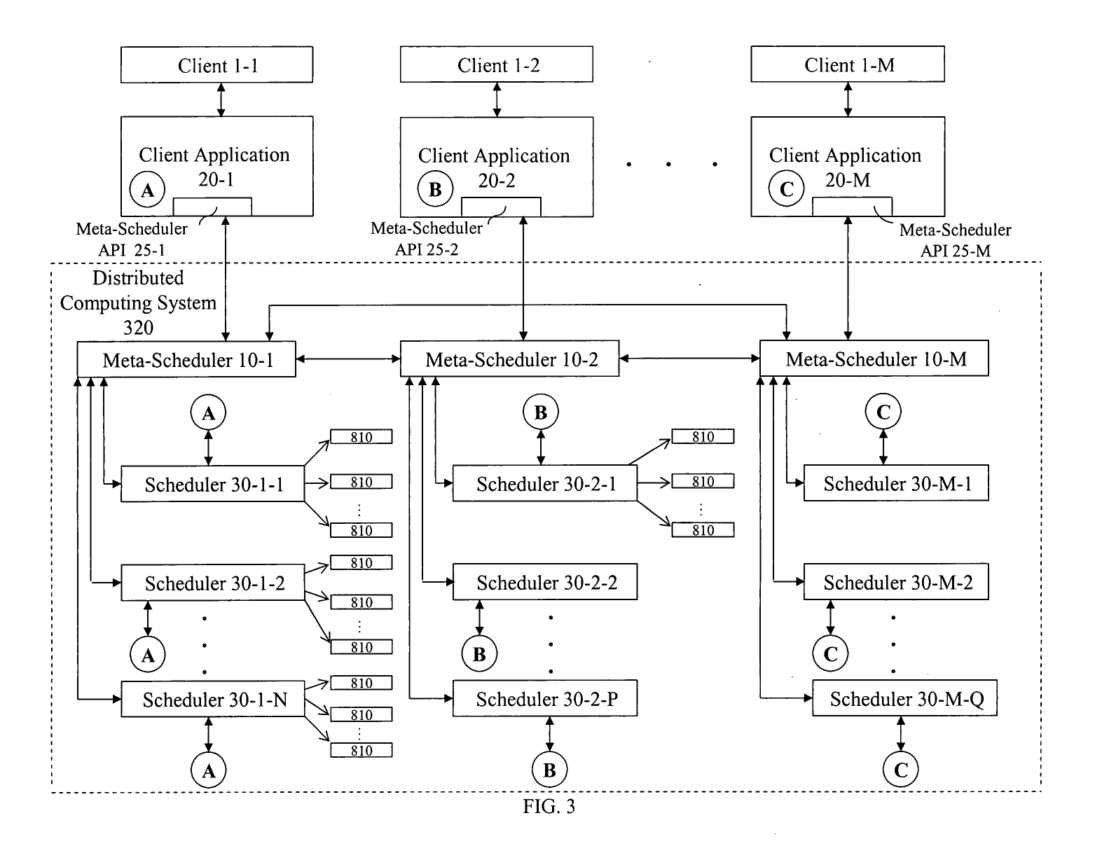

As shown in FIGS. 1 and 3, certain embodiments of the scheduler 30 may communicate with a meta-scheduler 10, one or more client applications 20, and one or more computing resources 810. For example, as shown in FIG. 3, each scheduler 30-1-1, 30-1-2, etc. in communication with meta-scheduler 10-1 may also be in more direct communication with client application 20-1. As shown in FIG. 1, schedulers 30-1, 30-2 etc. may communicate with client applications 20-1, 20-2, etc. via a network 200.

B. Meta-Scheduler 10

In one embodiment, a meta-scheduler 10 may be middleware software used with one or more distributed computing system(s) or grid(s) 300 (e.g., a “compute backbone”, or variant thereof, as described in U.S. Pat. No. 6,895,472) to provide more scalable and reliable switching and routing capabilities between grid clients 1-1, 1-2, etc. and grid clusters 700-1, 700-2, etc. In one embodiment, work may be routed between the meta-scheduler 10 and the scheduler 30 via an abstraction layer called a “virtual distributed resource manager” (VDRM) 19 that takes the meta-scheduler 10 format of the work description and translates it to the idiom particular to a specific scheduler 30. In this embodiment, the cluster schedulers 30-1, 30-2, etc. may be responsible for fine-grained work distribution to the actual compute resources 810-1, 810-2, etc., while the meta-scheduler 10 takes work from the client applications 20-1, 20-2, etc. and determines the appropriate cluster scheduler 30-1, 30-2, etc. to perform the computing work. The cluster(s) 700-1, 700-2, etc. available to any particular application 20 may or may not be predefined.

A grid 300 includes a set of hosts on which work can be scheduled by a meta-scheduler 10, and may have one or more clusters 700-1, 700-2, etc. each containing many CPUs (perhaps tens of thousands) 810-1, 810-2, etc. A cluster 700 thus may be a subset of a grid 300 that is being managed by a single DRM instance 30 (i.e., a “scheduler” for the cluster of computing resources, whether the number and type of resources are static, known to the scheduler, and located in one place, or dynamically discovered by the scheduler 30).

As shown in FIGS. 1 and 3, in embodiments of the present invention, the meta-scheduler 10 or meta-schedulers 10-1, 10-2, etc. may complement a grid's 30 existing job-scheduler software 30 by providing meta-scheduling across several grid clusters 700-1, 700-2, etc. (which may be heterogeneous) at an arbitrary and selectable amount of granularity. In particular, a meta-scheduler 10 of one embodiment may distribute work at an application level and/or at a job level—the granularity can be adjusted for the needs of a particular application 20. By residing functionally “upstream” of each cluster's scheduler software 30 (i.e., between grid clients 1-1, 1-2, etc. and schedulers 30-1, 30-2, etc. of computing resources 810-1, 810-2, etc. within clusters 700-1, 700-2, etc.), the meta-scheduler 10 software may dynamically control where and how work is scheduled and executed across all or many portions of an entire distributed computing system(s) 300 including, for example, scheduling and execution on computing resources tied to datacenter-type clusters 700 and/or computing resources in opportunistically discovered clusters (e.g., a cluster of idle desktop computers 810-5, 810-6, etc. identified and scheduled by Condor software 30-2). The meta-scheduler 10 of one embodiment may enable distribution of work to multiple heterogeneous clusters 700-1, 700-2, etc. as if they were one large pool of resources.

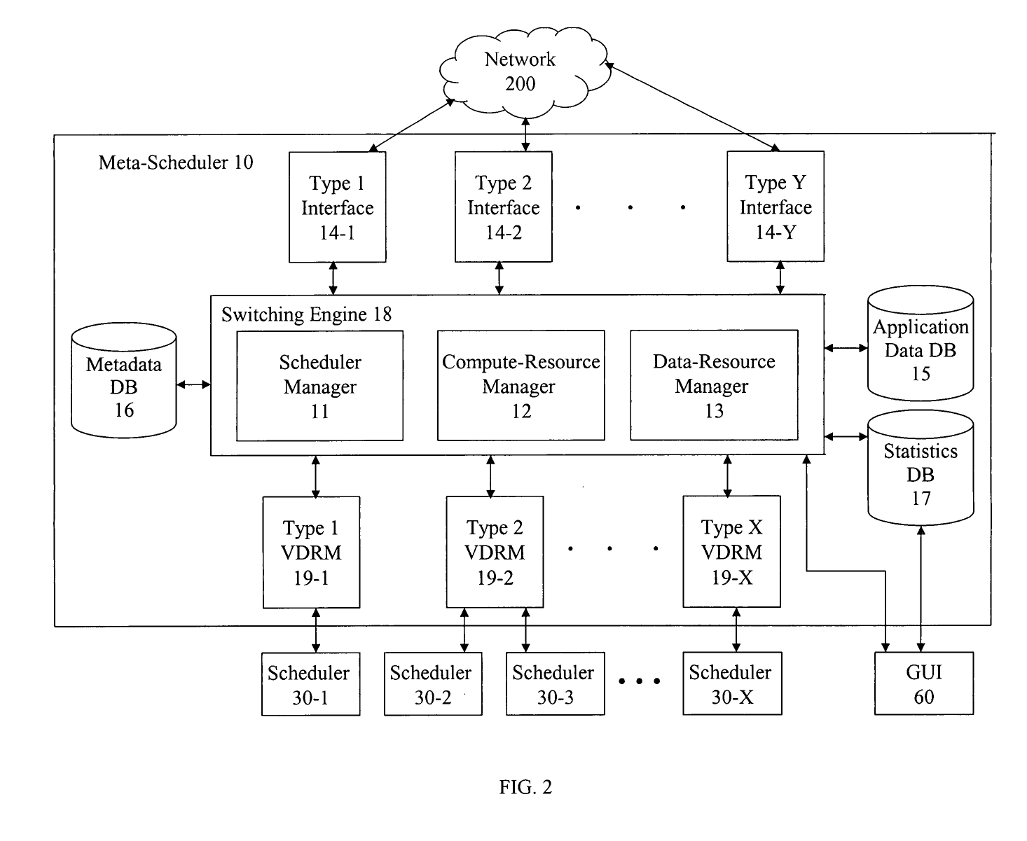

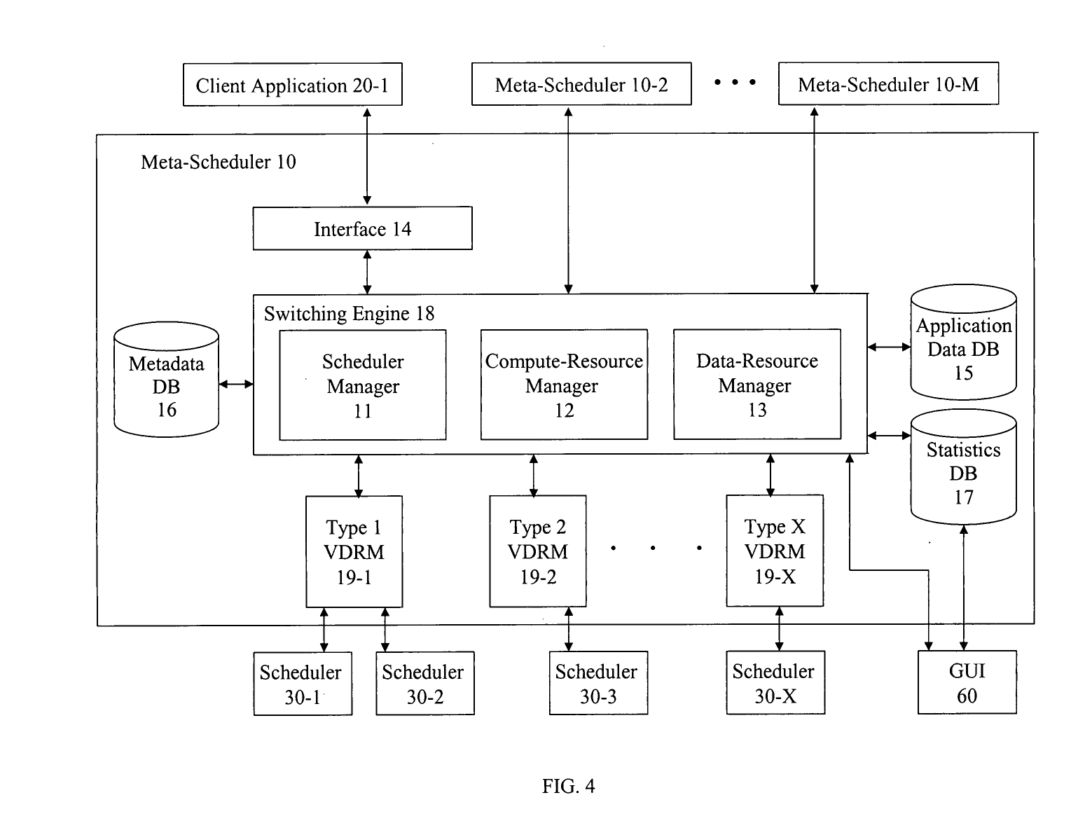

In certain embodiments, shown in FIGS. 2 and 4, the meta-scheduler 10 may have an interface, provided by a VDRM 19, to each kind of scheduler 30. In such embodiments, the VDRM 19 may allow the meta-scheduler 10 to present to a client application 20 a common interface to all schedulers 30 and clusters 700. This VDRM 19 may do so by providing an abstraction layer between that meta-scheduler 10 and the schedulers 30-1, 30-2, etc. with which it is in communication. In one embodiment, this may be achieved by creating a common semantic model known to all components of the meta-scheduler 10 and VDRM 19. This isolation helps ensure that the switching engine 18 of the meta-scheduler 10 and the VDRM 19 are not affected by the addition of a new kind of scheduler 30.

Existing grid-scheduling software 30, bounded by a cluster 700, may know how to take a job submitted for computation, break it down into constituent tasks, and distribute the tasks to the cluster's computers 810-1, 810-2, etc. for calculation. Such cluster-management software may use algorithms for distributing work with great efficiency for achieving high performance computing. But because conventional grid scheduling software typically has proprietary and customized semantic models for representing jobs and tasks, it may be incumbent on the VDRM 19 to take the canonical form of task- and job-definition known to the meta-scheduler 10 and translate it to the particular idiom of the scheduler's 30 software 36. This enables the meta-scheduler 10 of one embodiment to encapsulate the DRM 30 integration to a single point, simplifying the process of integrating new schedulers 30-J, 30-K, etc.

The meta-scheduler 10 of one embodiment may further provide a common service-provider interface (SPI) 14-1, 14-2, etc., which allows client requests to be translated into the particular idiom required by a target DRM 30 via the VDRM 19. The specific embodiment of an SPI 14 may be customized for a particular enterprise or may adhere to an industry standard, such as DRMAA (Distributed Resource Management Application API), JSDL (Job Submission Description Language), or a Globus set of standards.

The meta-scheduler 10 of one embodiment may also provide optional automatic failover capabilities, such as routing to an alternative cluster 700-Y when a primary cluster 700-X is unavailable or at maximum capacity. In addition, the meta-scheduler 10 may further enable a client 1 to submit an application 20 to one or more compatible clusters 700 (e.g., desktop clusters (implemented with the Condor DRM) and/or scavenging datacenter clusters (also implemented with, e.g., Condor)) without requiring the client 1 to know necessarily which cluster(s) 700 will receive the work.

As shown in FIGS. 2 and 4, embodiments of a meta-scheduler 10 functionally may include a scheduler manager 1, a computer-resource manager 12, a data resource manager 13, and a number of interfaces for communicating with other components of a broader distributed computing system 300. The scheduler manager 11 may be responsible for receiving job requests from the client applications 20-1, 20-2, etc. and determining the appropriate VDRM 19 to receive the work. The scheduler manager 11 may make this determination with input from the computer-resource manager 12, which may be in continuous communication with the VDRMs 19-1, 19-2, etc. to determine availability and current workload of the clusters 700-1, 700-2, etc. The data-resource manager 13 may be responsible for ensuring that the underlying data required to complete a particular job is co-located with the correct VDRM 19.

As shown in FIG. 1, the meta-scheduler 10 of one embodiment may be in communication with a number of clients 1-1, 1-2, etc. through appropriate interfaces 14-1, 14-2, etc. and/or application program interfaces (APIs) 25 to receive and schedule work from a number of applications 20-1, 20-2, etc. As shown in FIG. 3, according to another embodiment, each meta-scheduler 10-1 may be in communication with one client 1 through an appropriate interface 14 and/or API 25, as well as one or more other meta-schedulers 10-2, 10-M, etc., to receive and schedule work from one application 20 based on telemetry data from the cluster schedulers 30-1, 30-2, etc. as well as other meta-schedulers 10-2, 10-M, etc. In both such embodiments, a meta-scheduler 10 is also in communication with a number of grid clusters 700-1, 700-2, etc. through one or more appropriate VDRMs 19 to manage communications with the corresponding DRM 30 for each cluster 700. In such an arrangement, each scheduler 30 is in communication with and in charge of scheduling work and collecting results from a single cluster 700. In addition, the meta-scheduler 10 may include or be in communication with an application data repository 15 and a meta-data database 16, which may be used to persist the underlying data required to complete submitted jobs and to retain pre-defined rules to assist the meta-scheduler 10 in performing its switching operations, respectively. Also, the meta-scheduler 10 may contain a statistics database 17 that includes information about what work has been performed by the meta-scheduler 10 and/or the clusters 700-1, 700-2, etc.

According to one embodiment, an API 25 residing on a local computer provides an interface between an application 20 and the meta-scheduler 10. Such an API 25 may use a transparent communication protocol, such as hypertext transfer protocol (HTTP) or its variants, and a standardized data format, such as extensible markup language (XML), to provide communications between one or more applications 20-1, 20-2, etc. and one or more meta-schedulers 10-1, 10-2, etc. One example of an API 25 is the open source standard DRMAA client API.

The meta-scheduler 10 of one embodiment may also be in communication with a graphical user interface (GUI) 60 for managing global grid operations and also that may: (1) allow a client 1 to submit an application 20 to the grid for computation; and/or (2) allow monitoring of (i) the status of different system components, (ii) the status of jobs, regardless of where on the grid 300 they are being executed, (iii) the ability to deploy a service once and have it deployed throughout the grid to guarantee consistent code everywhere, and (iv) other operating metrics of interest selected by the client 1. The GUI 60 may achieve these functions by receiving telemetry data from each grid cluster 700-1, 700-2, etc. on its own state of affairs. Because each cluster's management software has its own idiom for representing grid activities, the VDRM 19 of one embodiment provides a common semantic model for representing grid activity in a way understandable to the GUI 60. In this way, the GUI 60 may provide a single, unified view of the grid 300 without unduly burdening the providers of grid-scheduling software to comply with a particular idiom of meta-scheduler 10.

Indeed, in one embodiment, the GUI 60 may allow all application- and operation-specific data to be captured in a single GUI 60 for access and display in one place. Conventional grid-scheduling software providers often align their GUIs with their cluster strategy, thus requiring a client 1 to open many web browsers (one for each grid cluster) to monitor the progress of an application 20. Other conventional grid-scheduling software providers have no GUI functionality at all, and instead rely on command-line tools for monitoring grid operations. Both of these conventional strategies may have certain drawbacks.

The GUI 60 may be an online tool that allows a client 1 to see what resources are being used for a particular application 20, and where portions of that application are being processed in the event maintenance is required. Additional users of the GUI 60 may include application developers and operations/maintenance personnel. In one embodiment, the GUI 60 may be a personal computer in communication with the statistics database 17, which contains information on the work performed by the meta-scheduler 10.

### II. Method Embodiments of the Invention

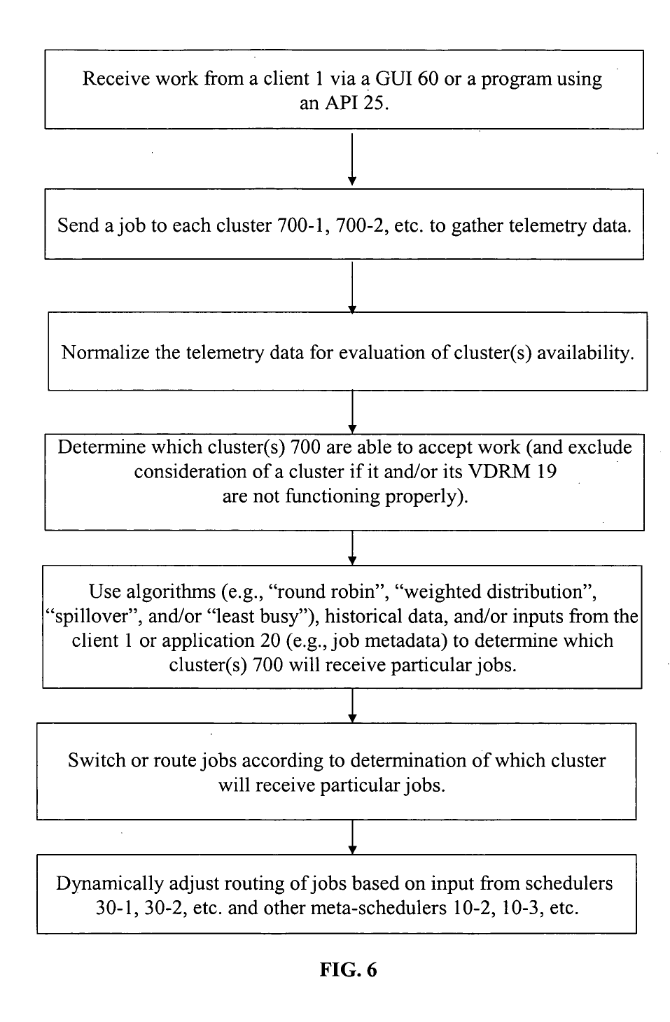

Having described the structure and functional implementation of certain aspects of embodiments of the meta-scheduler 10, the operation and use of certain embodiments of the meta-scheduler 10 will now be described with reference to FIGS. 6-8, and continuing reference to FIGS. 1-5.

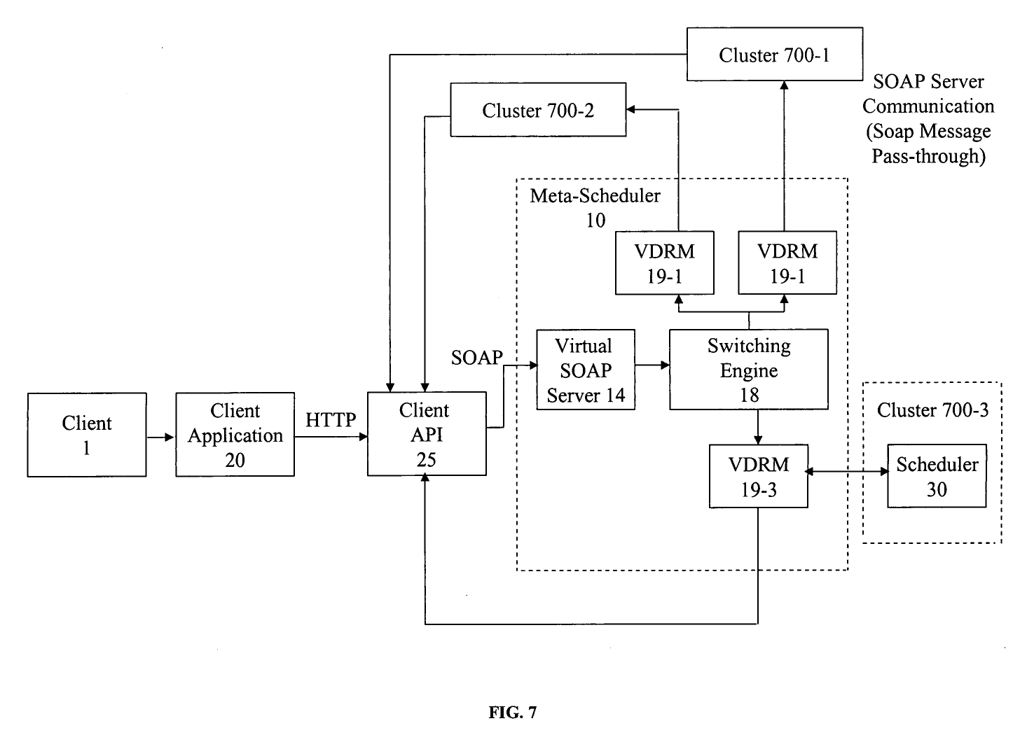

Certain method embodiments for allocating work to one or more clusters using a meta-scheduler 10 are shown in FIG. 6. In one embodiment (e.g., as shown in FIG. 7), a client 1 may, for example, use a GUI 60 to submit a job to a grid 300 for computation. In another embodiment (e.g., as shown in FIGS. 1 and 3), a client 1 may, for example, use a computer program that leverages an API 25 to programmatically submit one or more jobs for computation. The meta-scheduler 10 of one embodiment may know (or proceed to determine) whether and which particular clusters 700-1, 700-2, etc. are able to accept and compute work at a particular time. The meta-scheduler 10 of one embodiment may know historical trends in grid usage (e.g., “at 8 a.m. every morning, clusters 1 through 10 get busy”). A meta-scheduler 10 may record availability data generated by the meta-schedulers 10-1, 10-2, etc., schedulers 30-1, 30-2, etc., and/or computing resources 810-1, 810-2, etc. In other embodiments, the aforementioned steps may occur in an alternative order. For example, a meta-scheduler 10 may record availability data generated by the meta-schedulers 10-1, 10-2, etc., schedulers 30-1, 30-2, etc., and/or computing resources 810-1, 810-2, etc. before a job is submitted for computation via a GUI 60 or API 25.

Based on scheduling algorithms, historical data, and/or input from the client 1 and/or application 20, the meta-scheduler 10 may then determine which cluster(s) 700 will receive particular jobs by predicting workload and resource-availability based on historical trends. Next, the meta-scheduler 10 may switch or route those jobs accordingly.

The meta-scheduler 10 of one embodiment may identify the client 1 submitting jobs from a particular application 20, and route those jobs to a particular cluster 700 known by the meta-scheduler 10 to have the necessary resources (e.g., data storage, specific data, and computation modules) for executing that application 20. The meta-scheduler 10 may also route certain jobs of an application 20 to a cluster 700-1 that has more resources available than other clusters 700-2, 700-3, etc. The meta-scheduler 10 may further route some jobs to one cluster 700-1 and other jobs to another cluster 700-2 based on the availability of the resources within each cluster 700. In one embodiment, the meta-scheduler 10 routes work to one or more clusters 700-1, 700-2, etc. by telling the client application 20 where to send that work (i.e., which scheduler(s) 30-1, 30-2, etc. to contact).

There are several examples of algorithms that can be leveraged by the meta-scheduler 10 to determine how work may be allocated between grid clusters 700-1, 700-2, etc. All of the following examples assume normal functioning of the cluster 700 and corresponding VDRM 19. In one embodiment, the absence of normal functioning of the cluster 700 and corresponding VDRM 19 automatically excludes the cluster 700 from consideration for receiving work.

A first example of an allocation technique may be a “round robin” technique, in which work may be switched between clusters 700-1, 700-2, etc. in sequence, distributing one job to each cluster 700 before putting a second job in any cluster 700. This sequential job distribution may then be repeated, going back to a first cluster 700-1 when the meta-scheduler 10 has distributed a job to the last cluster 700-N.

A second example may be a “weighted distribution” technique, which is a variant of the “round robin” technique. In the weighted distribution technique, a percentage of jobs may be defined a priori for each cluster 700-1, 700-2, etc. The meta-scheduler 10 tracks how many jobs have been submitted to each cluster 700 and submits work to the largest percentage cluster 700 that is below its target. For example, suppose there are three clusters 700-1, 700-2, and 700-3 weighted 80, 10, and 10, respectively. The first job would go to a first cluster 700-1, the second job to a second cluster 700-2, the third job to a third cluster 700-3, and the fourth through tenth jobs to the first cluster 700-1.

Other algorithms leverage the meta-scheduler's ability to understand how busy a grid cluster 700 may become, where “busy” is defined by CPU or other compute-resource utilization versus total cluster capacity and/or grid scheduler job-queue depth. One busyness algorithm may be a “spillover” technique, where a threshold for cluster busyness may be defined in the meta-scheduler 10. For example, all work may be routed to a primary cluster 700-1 until it becomes too busy by the above definition, at which point work may be routed to a secondary cluster 700-2 for processing. This “spillover” technique can be arbitrarily deep, as there can be a tertiary cluster 700-3 for spillover from the secondary cluster 700-2, and a quaternary cluster 700-4 for spillover from the tertiary cluster 700-3, etc. Another busyness strategy may be “least busy,” where the meta-scheduler 10 simply routes work to the least-busy cluster 700.

Another set of algorithms can leverage job metadata to make meta-scheduler 10 switching decisions. Job metadata may contain explicit quality of service hints (e.g., “only schedule this job in fixed-resource grid clusters”), specific geographic requirements (e.g., “only schedule this job in New York”), or specific resource requirements (e.g., “only schedule this job where data set X is present”).

In addition, these algorithms may be used in conjunction with one another to create very complex job-switching logic within the meta-scheduler 10. For example, a grid application may have three datacenters in London and two in New York. A client 1 may decide that it wants all work distributed between the London datacenters in the course of normal operations, and spillover work distributed to New York in cases of extreme workload. In one embodiment, the three London datacenters could be aggregated into a group whose work is split via a “least busy” algorithm, and the New York datacenters would be placed in a group that received spillover work from London. The work could be distributed between the two New York datacenters by a “round robin” algorithm, because the latency between the London-based meta-scheduler 10 may make the telemetry data from the New York clusters less reliable.

The meta-scheduler 10 of one embodiment may obtain each cluster's telemetry data (e.g., identification of resources and how busy those resources are at a particular time) by sending a job to the scheduler 30-1, 30-2, etc. of each cluster 700-1, 700-2, etc. The job gathers data about how “busy” the cluster 700 is (e.g., how long is the queue, how many CPUs are available to do work, how many CPUs are being used to do work presently, etc.). If, for example, the meta-scheduler 10 sends a job to a particular cluster 700 and no results are returned, the meta-scheduler 10 may consider that cluster to be down or otherwise unavailable. In such a case, the meta-scheduler 10 may choose not to send work to that cluster 700 and to alert the distributed computing system 300, GUI 60, and/or maintenance operations. The results returned by the jobs the meta-scheduler 10 sends to the clusters 700-1, 700-2, etc. may be normalized within the meta-scheduler 10 to allow an “apples-to-apples” comparison to take place. To allow this comparison, the meta-scheduler 10 may apply a universal translator to the messages received from each cluster 700-1, 700-2, etc., and then make routing decisions based on a uniform set of metrics. In one embodiment, the VDRM 19 may collect telemetry data from the grid scheduler 30 and translate that data into the idiom of the meta-scheduler 10. For example, each grid scheduler 30 software may have its own paradigm for collecting the queue-depth of jobs waiting to be distributed to resources in the cluster 700. Such a VDRM 19 may collect the queue-depth information and report it to the meta-scheduler 10.

As shown in FIG. 7, in one embodiment a client 1 may access a grid 300 by submitting an HTTP request (e.g., supplying a particular uniform resource locator (URL)). A client application 20 may then be prompted to submit work (e.g., using an API 25) to a meta-scheduler 10 via, for example, simple object access protocol (SOAP). As shown in FIG. 7, the switching engine 18 may send certain jobs to “type 1” clusters 700-1, 700-2 via one or more “type 1” VDRMs 19-1. The switching engine 18 may also send other jobs to a “type 2” cluster 700-3 via a “type 2” VDRM 19-2. Each cluster 700-1, 700-2, 700-3 may communicate results back to the application 20 using, for example, Security Service Module (SSM) communication via SOAP.

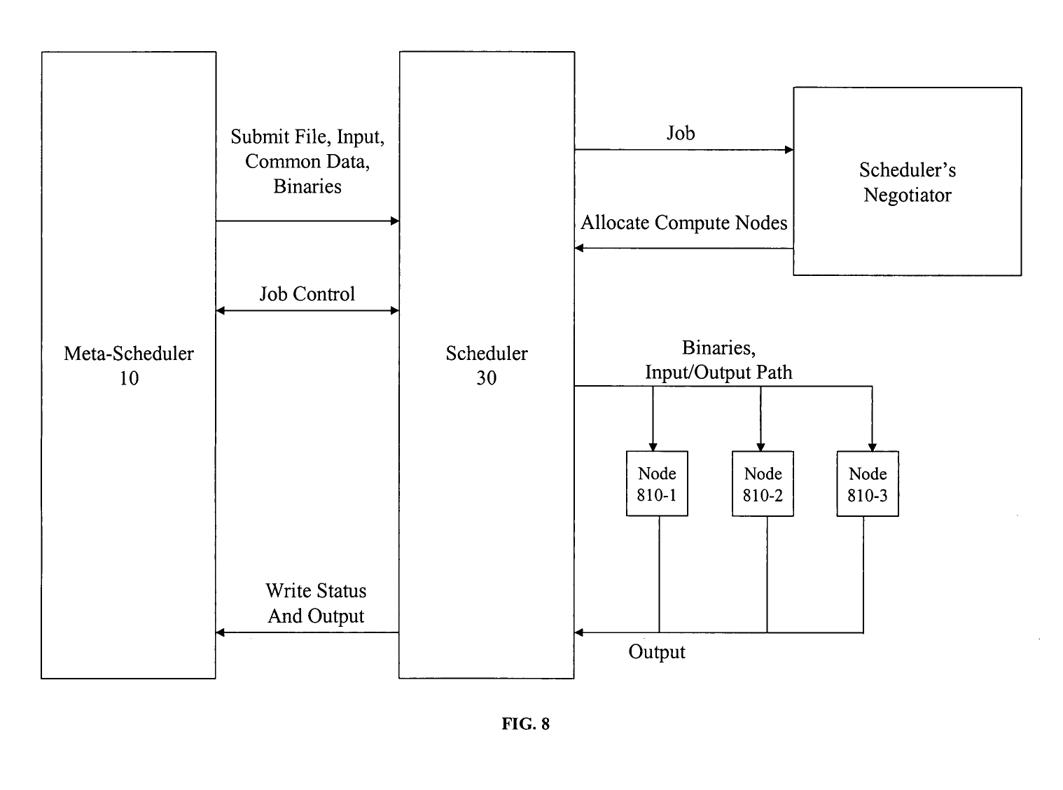

As shown in FIG. 8, according to one embodiment, a meta-scheduler 10 may pass file, input, common data, binaries, and job-control information to a scheduler 30. Using this information, a job-allocation function (i.e., “negotiator”) of the scheduler 30 may allocate specific jobs to specific nodes 810-1, 810-2, etc. Upon completion of the jobs, the scheduler 30 may pass the results back to the meta-scheduler 10 and also report availability status.

As mentioned above, in one embodiment of the meta-scheduler 10, routing decisions may be based on input criteria that are application 20 specific and/or customized for a particular application 20. As a first example, a particular application 20 may have specific resources (e.g., a database or a filer) that it expects to be able to connect with in order to be able to run its work. When a request for resources is made, the meta-scheduler 10 of one embodiment may search for clusters 700-1, 700-2, etc. that have resources needed by the client 1 (perhaps there are seven of ten total clusters that qualify) and then may rank those clusters in terms of availability and compatibility. For example, if ten clusters are in communication with the meta-scheduler 10, but only seven such clusters have the databases needed for a particular application 20, the meta-scheduler 10 of one embodiment may create a ranked list of only those seven clusters based on availability. The three incompatible clusters may not be ranked at all. As a second example, an application 20 may include routing rules designed to customize grid use for a client's 1 specific needs. Those routing rules may be provided to the meta-scheduler 10 and may include factors such as: (1) the time-sensitivity of jobs; (2) the type and amount of data collection necessary to complete the jobs; (3) the compute distances (i.e., GWAN, WAN, LAN) between resources; and (4) the levels of cluster activity.

In some distributed computing systems 300-1, clusters 700-1, 700-2, etc. may be configured to be able to support many different types of applications 20-1, 20-2, etc. and/or lines of business for an enterprise. So an application 20 may be developed in some cases with an understanding of which resources are in specific clusters 700-1, 700-2, etc. The meta-scheduler 10 may minimize the need for this consideration. In other distributed computing systems 300-2, the computing resources may be changing in number, kind, and quality. In addition to scheduling against a known and fixed number of resources, the meta-scheduler 10 of one embodiment may schedule against a dynamic set of resources.

One major complication of grid computing faced by certain organizations is the need to manage peak requests for computation resources. Typically, those organizations have had to purchase additional hardware to meet this demand—usually coinciding with month-end, quarter-end, and year-end processing. This may be inefficient, as the hardware required for peak times may remain idle during normal operations. The meta-scheduler 10 may help address this situation by allowing integration of additional third-party computing resources that can be added to a grid 300 for a short period of time on an as-needed basis. Examples may include SunGrid, IBM On-Demand, and Amazon Elastic Compute Cloud (EC2). The meta-scheduler 10 may simplify integration of the on-demand compute grids with their enterprise applications.

Although illustrative embodiments have been shown and described herein in detail, it should be noted and will be appreciated by those skilled in the art that there may be numerous variations and other embodiments which may be equivalent to those explicitly shown and described. For example, the scope of the present invention is not necessarily limited in all cases to execution of the aforementioned steps in the order discussed or to the use of all components addressed above. Unless otherwise specifically stated, the terms and expressions have been used herein as terms of description and not terms of limitation. Accordingly, the invention is not to be limited by the specific illustrated and described embodiments (or the terms or expressions used to describe them) but only by the scope of the appended claims.

We claim:

1. A system, comprising:
a plurality of grid-cluster schedulers, wherein each grid-cluster scheduler comprises software in communication with a plurality of computing resources, wherein each of said computing resources has an availability, and wherein said grid-cluster scheduler is configured to:
obtain a quantity of said computing resources as well as said availability; and
allocate work for a client application to one or more of said computing resources based on said quantity and availability of said computing resources; and
a meta-scheduler in communication with said plurality of grid-cluster schedulers, wherein said meta-scheduler is configured to direct work dynamically for one or more client applications to at least one of said plurality of grid-cluster schedulers based at least in part on data from each of said grid-cluster schedulers.

2. The system of claim 1, wherein said plurality of computing resources is a subset of a distributed computing system.

3. The system of claim 2, wherein said subset is one of a plurality of subsets of computing resources of said distributed computing system, and wherein said work comprises data descriptive of an indication informing said meta-scheduler that said work must be scheduled on a particular type of subset of computing resources.

4. The system of claim 2, wherein said subset is one of a plurality of subsets of computing resources of said distributed computing system, and wherein said work comprises data descriptive of an indication informing said meta-scheduler that said work must not be scheduled on a particular type of subset of computing resources

5. The system of claim 1, wherein said meta-scheduler is a middleware software device.

6. The system of claim 1, wherein said quantity of resources of said plurality of computing resources is substantially static and known to said grid-cluster scheduler.

7. The system of claim 6, wherein said grid-cluster scheduler further knows a type of resource of said plurality of computing resources.

8. The system of claim 1, wherein said quantity of resources of said plurality of computing resources is dynamically discovered by said grid-cluster scheduler.

9. The system of claim 8, wherein said grid-cluster scheduler further knows a type of resource of said plurality of computing resources.

10. The system of claim 1, wherein said meta-scheduler comprises an interface to each of said grid-cluster schedulers, wherein said grid-cluster schedulers are of different types.

11. The system of claim 10, wherein said interface translates a request from a client of a distributed computing system into an idiom required by a grid-cluster scheduler selected as a target by said meta-scheduler.

12. The system of claim 1, wherein said meta-scheduler is in communication with a graphical user interface (GUI).

13. The system of claim 12, wherein said GUI displays a single and application-centric view of said computing resources.

14. The system of claim 1, wherein said meta-scheduler is in communication with an additional meta-scheduler and receives, from said additional meta-scheduler, data comprising an indication of how said additional meta-scheduler directed work.

15. The system of claim 1, wherein said meta-scheduler directs work using a round-robin algorithm.

16. The system of claim 1, wherein said meta-scheduler directs work using a weighted distribution algorithm.

17. The system of claim 1, wherein said meta-scheduler directs work using a spillover algorithm.

18. The system of claim 1, wherein said meta-scheduler directs work based on a busyness of each of said cluster-schedulers.

19. The system of claim 1, wherein said meta-scheduler directs work based on an instruction from said client application.

20. The system of claim 1, wherein said meta-scheduler further comprises a common semantic model for communicating with heterogeneous grid-cluster schedulers.

21. A middleware software program functionally upstream of and in communication with one or more cluster schedulers of one or more distributed computing systems, wherein said middleware software program dynamically controls where and how work from a client application is allocated to said cluster schedulers.

22. A method, comprising:
receiving, for computation by one or more clusters of a distributed computing system, work of a client application;
sending a job to each said cluster and gathering telemetry data based on a response from each said cluster to said job;
normalizing said telemetry data from each said cluster;
determining which of said clusters are able to accept said work of said client application; and
determining which of said clusters will receive a portion of said work.

23. The method of claim 22, wherein said determining comprises using a round-robin algorithm.

24. The method of claim 22, wherein said determining comprises using a weighted distribution algorithm.

25. The method of claim 22, wherein said determining comprises using a spillover algorithm.

26. The method of claim 22, wherein said determining comprises considering a busyness of each of said cluster-schedulers.

27. The method of claim 22, wherein said determining comprises considering an instruction from said client application.

28. The method of claim 22, further comprising adjusting dynamically which of said clusters will receive said portion of said work.

29. A system, comprising:
means for receiving, for computation by one or more clusters of a distributed computing system, work of a client application;
means for sending a job to each said cluster and gathering telemetry data based on a response from each said cluster to said job;
means for normalizing said telemetry data from each said cluster;
means for determining which of said clusters are able to accept said work of said client application; and
means for determining which of said clusters will receive a portion of said work.
